(19) United States
(12) Patent Application Publication
(10) Pub. No.: US 2023/0134120 A1
(43) Pub. Date: May 4, 2023

(54) DELIVERY ROBOT

(71) Applicant: LG ELECTRONICS INC., Seoul (KR)

(72) Inventors: Haklim LEE, Seoul (KR); Jeeyoung CHEON, Seoul (KR)

(73) Assignee: LG ELECTRONICS INC., Seoul (KR)

(21) Appl. No.: 17/565,992

(22) Filed: Dec. 30, 2021

(30) Foreign Application Priority Data
Oct. 29, 2021 (KR) PCT/KR2021/015370

(51) Int. Cl. G06Q 10/08

(52) U.S. Cl. CPC G06Q 10/083

(57) ABSTRACT

The present disclosure relates to a delivery robot capable of transporting a tray and the like. The delivery robot includes a main body configured to be movable with respect to the ground, a coupling module coupled to one surface of the main body, and a locking unit coupled to a tray that is configured to be movable. The coupling module includes an actuator configured to be operated to be coupled with the locking unit when the coupling module and the tray are located adjacent to each other.

### CROSS-REFERENCE TO RELATED APPLICATION

Pursuant to 35 U.S.C. § 119, this application claims the benefit of an earlier filing date and right of priority to International Application No. PCT/KR2021/015370, filed on Oct. 29, 2021, the contents of which are hereby incorporated by reference herein in its entirety.

### TECHNICAL FIELD

The present disclosure relates to a delivery robot capable of transporting a tray or the like.

### BACKGROUND ART

Competition for transporting products in online and offline markets is heating up day by day, and product transportation on the day of purchase is sometimes provided for better convenience of the user.

In recent years, unmanned mobile robots for transporting products have been used on the ground or in the air, and relevant laws and regulations are being gradually being prepared.

A robot may be a machine that automatically deals with or performs a task given by its own capabilities. In particular, a robot having a function of recognizing an environment and performing an operation based on self-determination may be referred to as an intelligent robot, and various services may be provided using the intelligent robot.

Meanwhile, a delivery system using a robot requires information such as a map, a route, and the like of a traveling or driving region to provide a delivery service on the traveling region. Such information should be accumulated to establish a service, which allows a robot to deliver a product to a destination.

In addition, in recent years, daily life logistics such as delivery of goods at supermarkets, delivery logistics, and movement of logistic goods within a building are entering the scope of the existing logistics industry. Such daily life logistics require a structure that can transport logistic goods in various forms that are not restricted or affected by an appropriate amount of logistics in line with various living environments.

In particular, a delivery robot used in transporting daily logistic goods should recognize the surrounding environment to operate according to the mapped map. Further, there is a growing need for a delivery robot that can cover both small and large amounts of various types of logistics.

### DISCLOSURE OF INVENTION

### Technical Problem

The present disclosure is directed to providing implementations that can address the aforementioned necessity.

In detail, the present disclosure describes a delivery robot that can actively recognize the surrounding environment. The present disclosure also describes a delivery robot that can transport logistic goods whether it is a small or large amount.

### Solution to Problem

According to one aspect of the subject matter described in this application, a delivery robot includes a main body configured to be movable with respect to a ground, a coupling module coupled to one surface of the main body, and a locking unit coupled to a tray that is configured to be movable. The coupling module includes an actuator configured to be driven to be coupled with the locking unit when the coupling module and the tray are located adjacent to each other.

Implementations according to this aspect may include one or more of the following features. For example, the main body may include a moving unit including a wheel configured to be movable with respect to the ground, an extension unit extending in one direction from one end of the moving unit, and a display unit extending from an end portion of the extension unit at a predetermined angle with respect to the extension unit.

In some implementations, the moving unit may include a coupling part disposed on an upper surface thereof and through which the coupling module is coupled, and a TOF camera disposed at a lateral surface thereof and provided in plurality spaced apart from one another along a periphery of the lateral surface.

In some implementations, the moving unit may further include a first wheel configured to move the main body in a direction in which the extension unit is defined and a direction opposite to the direction in which the extension unit is defined, and a second wheel configured to be steerable to allow the main body to rotate.

In some implementations, the moving unit may further include a main body lidar disposed toward the front and disposed above the TOF camera.

In some implementations, the extension unit may extend perpendicular to the upper surface of the moving unit, and the extension unit may include a camera part that is provided at a front surface thereof and includes a camera capable of shooting terrain ahead, a speaker that transmits sound to the outside, and an engaging part disposed at a rear surface thereof and configured to fix at least one of the coupling module and the tray.

In some implementations, the display unit may include a display configured to display a state of the main body and output a screen for controlling the main body, an inclined part configured to support the display, and an angle adjustment part configured to adjust an angle of the display.

In some implementations, the coupling module may include a module body coupled to one surface of the main body, and a docking part provided at an upper surface of the module body in a protruding manner and configured to determine whether or not docking is completed according to proximity of the tray. The actuator may include an actuator bar configured to move up when the tray and the coupling module are docked at the docking part, and a drive part configured to operate the actuator bar.

In some implementations, the docking part may be disposed adjacent to the extension unit. The actuator bar may be disposed in a direction opposite to the extension unit with respect to the docking part and be inserted into the module body before the coupling module and the tray are docked.

In some implementations, the module body may be provided with a front groove that is concavely recessed to allow the extension unit to be inserted therein, and a plurality of module TOF cameras may be provided at a lateral surface of the module body to be spaced apart from one another along a periphery of the module body.

In some implementations, the module body may include a module lidar formed toward the rear thereof and configured to scan a rear side of the main body.

In some implementations, the upper surface of the module body may be equal to or smaller than the upper surface of the moving unit, and the module body may include rolling pins disposed on the upper surface of the module body in a direction opposite to a direction in which the actuator bar is disposed and configured to be rotatable.

In some implementations, the locking unit may include a locking part mounted to one end of the tray and in which the actuator bar is inserted and a guide part extending from the locking part and having a width greater than a width of the locking part. At least a portion of the guide part may be guided by the rolling pins.

In some implementations, the guide part may include first portions extending from the locking part in an inclined manner, second portions having a width that corresponds to a separation distance between the rolling pins disposed at both sides of the module body and extending in a lengthwise direction of the guide part, and a third portion connecting the second portions disposed at both sides the locking part.

In some implementations, the first portions may be guided by the rolling pins when the coupling module approaches the locking part.

In some implementations, a gap may be defined between the coupling module and the second portions.

In some implementations, the coupling module may include a damper disposed at an upper surface of the coupling module, configured to surround the docking part, and extending along an extension direction of the extension unit.

In some implementations, the damper may include a damper groove through which the docking part is exposed to the outside and into which the docking part is inserted, and a front surface of the damper in which the damper groove is defined may protrude more to the actuator than a front surface of the docking part that is exposed to the outside.

In some implementations, the locking part may be provided with a locking groove into which the actuator bar is inserted, and the actuator bar may be disposed to be spaced apart from at least one of front and rear surfaces of the locking groove that define the locking groove.

In some implementations, a front surface of the locking part may be brought into contact with the damper when the tray moves forward relative to the main body as the main body is switched to a stationary state from a moving state.

### Advantageous Effects of Invention

A delivery robot according to an implementation of the present disclosure can provide large power along front and rear directions through a first wheel of a moving unit. Also, steering and rotation are enabled through the moving unit including a second wheel.

In addition, the delivery robot of the present disclosure may provide recognition of the front and rear of the delivery robot through an extension unit disposed at one side of the moving unit. Also, information regarding a distance or height of nearby objects can be identified through a Lidar of the moving unit, a TOF camera, and a camera part of the extension unit.

Further, the delivery robot of the present disclosure can be easily manipulated by a user through a display unit.

The delivery robot according to an implementation of the present disclosure may include a coupling module that is integrally coupled to a main body. As the coupling module is detachably connected to the main body, different types of coupling modules can be coupled to the main body according to a type of tray and the like, thereby increasing the use of the main body.

In the delivery robot according to an implementation of the present disclosure, as a damper is disposed to surround or cover a docking part, and a front surface of the damper protrudes more than a front surface of the docking part, the docking part can be prevented from being damaged by a locking part when the locking part is excessively moved toward the docking part.

### BRIEF DESCRIPTION OF DRAWINGS

FIG. 1 is a block diagram of a delivery system.

FIG. 2A is an exemplary view 1-a showing an example of a traveling region.

FIG. 2B is an exemplary view 1-b showing an example of a traveling region.

FIG. 3A is an exemplary view 2-a showing an example of a traveling region.

FIG. 3B is an exemplary view 2-b showing an example of a traveling region.

FIG. 4 is an exemplary view 3 showing an example of a traveling region.

FIGS. 5 and 6 are perspective views illustrating a delivery robot according to one implementation of the present disclosure.

FIG. 7 is a perspective view illustrating a delivery robot according to another implementation of the present disclosure.

FIG. 8 is a perspective view illustrating a tray and a locking unit according to one implementation of the present disclosure.

FIGS. 9 to 13 are views illustrating a process in which a coupling module and a locking unit are coupled by an actuator as the delivery robot in FIG. 5 moves to be adjacent to a tray.

FIG. 14 is a cross-sectional view illustrating a state of coupling the coupling module and the locking unit.

FIG. 15 is a cross-sectional view illustrating a coupled state of the delivery robot and the tray.

FIG. 16 is a cross-sectional view illustrating a positional relationship between the coupling module and the locking unit when the delivery robot that is coupled to the tray travels on an incline.

FIG. 17 is a cross-sectional view illustrating a positional relationship between the coupling module and the locking unit when the delivery robot that is coupled to the tray stops while traveling.

FIG. 18 is a front view illustrating a coupled state of the delivery robot and the tray.

### MODE FOR THE INVENTION

Description will now be given in detail according to exemplary implementations disclosed herein, with reference to the accompanying drawings. For the sake of brief description with reference to the drawings, the same or equivalent components may be provided with the same or similar reference numbers, and description thereof will not be repeated. In describing the present disclosure, if a detailed explanation for a related known function or construction is considered to unnecessarily divert the main point of the present disclosure, such explanation has been omitted but would be understood by those skilled in the art.

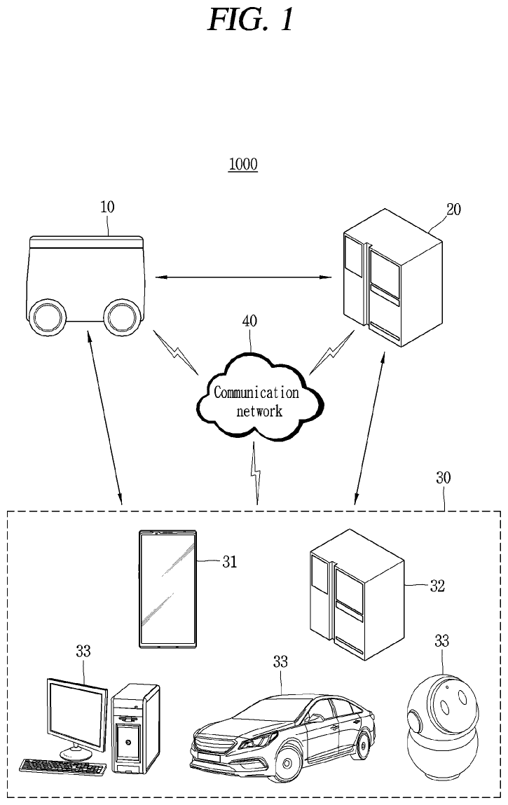

As illustrated in FIG. 1, a delivery system 1000 includes a delivery robot (DR, 10) that autonomously travels or self-drives in a traveling (or driving) region, and a control server 20 connected to communicate with the delivery robot DR through a communication network 40 so as to control an operation of the delivery robot DR.

In addition, the delivery system 1000 may further include one or more communication devices 30 connected to communicate with at least one of the delivery robot DR and the control server 20 to transmit and receive information to and from at least one of the delivery robot DR and the control server 20.

The delivery robot DR may be an intelligent robot that automatically processes or operates a task given by its own capabilities. For example, the intelligent robot may be an automated guided vehicle (AGV), which is a transportation device that moves on the floor by a sensor, a magnetic field, a vision device, and the like, or a guide robot that provides guide information to a user in an airport, a shopping mall, a hotel, or the like.

The delivery robot DR may be provided with a drive unit including an actuator or a motor to perform various physical operations such as moving a robot joint. For instance, the delivery robot DR may autonomously travel in the traveling region. Autonomous driving (or traveling) refers to a self-driving technology, and the delivery robot DR may be an autonomous driving vehicle (robot) that travels without a user's manipulation or with a user's minimal manipulation. A technology for maintaining a driving lane, a technology for automatically adjusting speed such as adaptive cruise control, a technology for automatically driving along a predetermined path or route, a technology for automatically setting a path when a destination is set, and the like may be all included in the autonomous driving.

In order to perform such autonomous driving, the delivery robot DR may be a robot to which artificial intelligence (Al) and/or machine learning is applied. The delivery robot DR may autonomously travel in the traveling region to perform various operations through the artificial intelligence and/or machine learning. For example, an operation according to a command designated by the control server 20 may be performed, or a self-search/monitoring operation may be performed.

Hereinafter, artificial intelligence and/or machine learning technology applied to the delivery robot DR will be described in detail.

Artificial intelligence (AI) refers to a field of studying artificial intelligence or a methodology capable of creating artificial intelligence, and machine learning refers to a field of studying a methodology for defining various problems dealt with in the field of artificial intelligence and solves them. The machine learning technology is a technology that collects and learns a large amount of information based on at least one algorithm to determine and predict information based on the learned information. The learning of information refers to an operation of recognizing the features of information, rules and determination criteria, quantifying a relation between information and information, and predicting new data using the quantified patterns. Machine learning is also defined as an algorithm that improves the performance of a certain task through continuous experience in the task.

Algorithms used by the machine learning technology may be algorithms based on statistics, for example, a decision tree that uses a tree structure as a prediction model, an artificial neural network that mimics neural network structures and functions of living creatures, genetic programming based on biological evolutionary algorithms, clustering of distributing observed examples to a subset of clusters, a Monte Carlo method of computing function values as probability using randomly-extracted random numbers, and the like. As one field of the machine learning technology, there is a deep learning technology of performing at least one of learning, determining, and processing information using the artificial neural network algorithm.

An artificial neural network (ANN) as a model used in machine learning may refer to all of models having a problem-solving ability, which are composed of artificial neurons (nodes) that form a network by synaptic connections. The artificial neural network may have a structure of connecting between layers and transferring data between the layers. The deep learning technology may be employed to learn a vast amount of information through the artificial neural network using a graphic processing unit (GPU) optimized for parallel computing.

The artificial neural network may be defined by a connection pattern between neurons in different layers, a learning process of updating model parameters, and an activation function of generating an output value. The artificial neural network may include an input layer, an output layer, and optionally one or more hidden layers. Each layer may include one or more neurons, and the artificial neural network may include a synapse that connects neurons to neurons. In the artificial neural network, each neuron may output a function value of an activation function for input signals being input through the synapse, a weight, a bias, and the like. The model parameters refer to parameters determined through learning, and include a weight of a synaptic connection, a bias of a neuron, and the like. In addition, a hyperparameter refers to a parameter that must be set prior to learning in a machine learning algorithm, and includes a learning rate, a repetition number, a mini-batch size, an initialization function, and the like.

The purpose of learning in an artificial neural network can be seen as determining the model parameters that minimize a loss function. The loss function may be used as an index for determining an optimal model parameter in the learning process of the artificial neural network.

Machine learning can be classified into supervised learning, unsupervised learning, and reinforcement learning according to a learning method.

The supervised learning may refer to a method of training an artificial neural network in a state where a label for learning data is given, and the label may refer to a correct answer (or result value) that the artificial neural network must infer when learning data is input to the artificial neural network. The unsupervised learning may refer to a method of training an artificial neural network in a state where no label is given for learning data. The reinforcement learning may refer to a learning method of training an agent defined in a certain environment to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. Hereinafter, machine learning is used in a sense including deep learning.

The delivery robot DR may be implemented without employing such artificial intelligence and/or machine learning technology, but a delivery robot to which the artificial intelligence and/or machine learning technology is applied will be mainly described as the delivery robot DR.

The traveling region in which the delivery robot DR operates may be indoors or outdoors. The delivery robot DR may operate in a zone partitioned by walls or pillars. In this case, the operation zone of the delivery robot DR may be set in various ways according to a design purpose, a task attribute of the robot, mobility of the robot, and other various other factors. In addition, the delivery robot DR may operate in an open zone that is not predefined. Further, the delivery robot DR may sense a surrounding environment to determine an operation zone by itself. The operation may be made through artificial intelligence and/or machine learning technology applied to the delivery robot DR.

The delivery robot DR and the control server 20 may be connected to communicate through the communication network 40 to transmit and receive data to and from each other. In addition, each of the delivery robot DR and the control server 20 may transmit and receive data to and from the communication device 30 through the communication network 40. Here, the communication network 40 may refer to a communication network that provides a communication environment for communication devices in a wired or wireless manner. For instance, the communication network 40 may be an LTE/5G network. In other words, the delivery robot DR may transmit and receive data to and from the control server 20 and/or the communication device 30 through an LTE/5G network. In this case, the delivery robot DR and the control server 20 may communicate through a base station that is connected to the communication network 40 or directly communicate without passing through the base station. Further, in addition to the LTE/5G network, other mobile communication technology standards or communication methods may be applied to the communication network 40. For example, the other mobile communication technology standards or communication methods may include at least one of Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), and the like.

The communication network 40 may include a connection of network elements such as hubs, bridges, routers, switches and gateways. The communication network 40 may include one or more connected networks, for instance, a multi-network environment, including a public network such as the Internet and a private network such as a secure enterprise private network. Access to the communication network 40 may be provided through one or more wired or wireless access networks. Furthermore, the communication network 40 may support various types of M2M communications (Internet of Things (IoT), Internet of Everything (IoE), and Internet of Small Things (IoST) that exchange and process information between distributed components such as things.

The delivery robot DR may perform an operation in the traveling region, and may provide information or data related to the operation to the control server 20 through the communication network 40. For instance, the delivery robot DR may provide a location of the delivery robot DR and information regarding a currently performing operation to the control server 20. In addition, the delivery robot DR may receive information or data related to the operation from the control server 20 through the communication network 40. For instance, the control server 20 may provide information regarding driving motion control of the delivery robot DR to the delivery robot DR.

The delivery robot DR may provide its own status (or state) information or data to the control server 20 through the communication network 40. Here, the status information may include information regarding a location, battery level, durability of parts, replacement cycle of consumables, and the like of the delivery robot DR. Accordingly, the control server 20 may control the delivery robot DR based on the information provided from the delivery robot DR.

Meanwhile, the delivery robot DR may provide one or more communication services through the communication network 40, and may also provide one or more communication platforms through the communication services. For instance, the delivery robot DR may communicate with a communication target using at least one service of enhanced mobile broadband (eMBB), ultra-reliable and low latency communications (URLLC), and massive machine-type communications (mMTC).

The enhanced mobile broadband (eMBB) is a mobile broadband service, through which multimedia content, wireless data access, and the like may be provided. In addition, more advanced mobile services such as a hot spot and wideband coverage for receiving explosively increasing mobile traffic may be provided through the eMBB. Large traffic may be received in an area with low mobility and high density of users through a hot spot. A wide and stable wireless environment and user mobility may be secured through wideband coverage.

The ultra-reliable and low latency communications (URLLC) service defines much more stringent requirements than the existing LTE in terms of data transmission/reception reliability and transmission delay, and includes 5G services for production process automation at industrial sites, telemedicine, telesurgery, transportation, safety, and the like.

The massive machine-type communications (mMTC) is a service that is not sensitive to transmission delay requiring a relatively small amount of data transmission. A much larger number of terminals general mobile phones, such as sensors may simultaneously access a wireless access network by the mMTC. In this case, the communication module of the terminal should be inexpensive, and improved power efficiency and power saving technology are required to allow operation for several years without battery replacement or recharging.

The communication service may further include all services that can be provided to the communication network 40 in addition to the eMBB, the URLLC, and the mMTC described above.

The control server 20 may be a server device that centrally controls the delivery system 1000. The control server 20 may control traveling and operation of the delivery robot DR in the delivery system 1000. The control server 20 may be provided in the traveling region to communicate with the delivery robot DR through the communication network 40. For instance, the control server 20 may be provided in any one of buildings corresponding to the traveling region. The control server 20 may also be provided in a place different from the traveling region to control the operation of the delivery system 1000. The control server 20 may be implemented as a single server, but may alternatively be implemented as a plurality of server sets, cloud servers, or a combination thereof.

The control server 20 may perform various analyses based on information or data provided from the delivery robot DR, and may control an overall operation of the delivery robot DR based on the analysis result. The control server 20 may directly control the driving of the delivery robot DR based on the analysis result. In addition, the control server 20 may derive useful information or data from the analysis result and output the derived information or data. Further, the control server 20 may adjust parameters related to the operation of the delivery system 1000 using the derived information or data.

At least one of the delivery robot DR and the control server 20 communicatively connected through the communication network 40 may be connected to communicate with the communication device 30 through the communication network 40. In other words, the delivery robot DR and the control server 20 may communicate with a device that can be communicably connected to the communication network 40 among the communication devices 30 through the communication network 40. At least one of the delivery robot DR and the control server 20 may also be connected to communicate with the communication device 30 through a communication method other than the communication network 40. In other words, at least one of the delivery robot DR and the control server 20 may be in communication with a device that can be communicably connected in a manner different from that of the communication network 40 among the communication devices 30. For example, at least one of the delivery robot DR and the control server 20 may be connected to communicate with the communication device 30 using at least one method of Wireless LAN (WLAN), Wireless Personal Area Network (WPAN), Wireless-Fidelity (Wi-Fi), Wireless Fidelity (Wi-Fi) Direct, Digital Living Network Alliance (DLNA), Wireless Broadband (WiBro), World Interoperability for Microwave Access (WiMAX), Zigbee, Z-wave, Blue-Tooth, Radio Frequency Identification (RFID), Infrared Data Association (IrDA), Ultrawide-Band (UWB), Wireless Universal Serial Bus (USB), Near Field Communication (NFC), Visible Light Communication, Light Fidelity (Li-Fi), and satellite communication. Other communication methods in addition to the above communication methods may also be used for the communication connection.

The communication device 30 may refer to any device and/or server capable of communicating with at least one of the delivery robot DR and the control server 20 through various communication methods including the communication network 40. For instance, the communication device 30 may include at least one of a mobile terminal 31, an information providing system 32, and an electronic device 33.

The mobile terminal 31 may be a communication terminal capable of communicating with the delivery robot DR and the control server 20 through the communication network 40. The mobile terminal 31 may include a mobile device such as a mobile phone, a smart phone, a wearable device, for example, a watch type terminal (smartwatch), a glass type terminal (smart glass), a head mounted display (HMD), a laptop computer, a digital broadcasting terminal, a personal digital assistant (PDA), a portable multimedia player (PMP), a navigation device, a slate PC, a tablet PC, an ultrabook, and the like.

The information providing system 32 may refer to a system that stores and provides at least one of information reflected in the traveling region or related to the traveling region, and information related to the operation of the delivery system 1000. The information providing system 32 may be a system (server) that is operable in connection with the delivery robot DR and the control server 20 to provide data and services to the delivery robot DR and the control server 20. The information providing system 32 may include at least one of all systems (servers) capable of being communicably connected to and exchanging information with the delivery robot DR and the control server 20. For instance, at least one of a database system, a service system, and a central control system may be included in the information providing system 32. A specific example of the information providing system 32 may include at least one of a service system of a manufacturer of the delivery robot DR, a service system of a manufacturer of the control server 20, a central (management) control system of a building corresponding to the traveling region, a service system of a provider that supplies energy to a building corresponding to the traveling region, an information system of a construction company of a building corresponding to the traveling region, a service system of a manufacturer of the mobile terminal 31, a service system of a communication provider that provides a communication service through the communication network 40, and a service system of a developer of an application applied to the delivery system 1000. In addition, the information providing system 32 may further include all systems operable in connection with the delivery system 1000 in addition to the above systems.

The information providing system 32 provides various services/information to electronic devices including the delivery robot DR, the control server 20, the mobile terminal 31, and the electronic device 33. The information providing system 32 may be implemented as a cloud to include a plurality of servers, perform calculations related to artificial intelligence that are difficult or time-consuming for the delivery robot DR, the mobile terminal 31, and the like to generate a model related to artificial intelligence, and provide relevant information to the delivery robot DR, the mobile terminal 31, and the like.

The electronic device 33 may be a communication device capable of communicating with at least one of the delivery robot DR and the control server 20 through various communication methods including the communication network 40 in the traveling region. For instance, the electronic device 33 may be at least one of a personal computer, a home appliance, a wall pad, a control device that controls facilities/equipment such as an air conditioner, an elevator, an escalator, and lighting, a watt-hour meter, an energy control device, an autonomous vehicle, and a home robot. The electronic device 33 may be connected to at least one of the delivery robot DR, the control server 20, the mobile terminal 31, and the information providing system 32 in a wired or wireless manner.

The communication device 30 may share the role of the control server 20. For instance, the communication device 30 may acquire information or data from the delivery robot DR to provide the acquired information or data to the control server 20, or acquire information or data from the control server 20 to provide the acquired information or data to the delivery robot DR. In addition, the communication device 30 may be in charge of at least part of an analysis to be performed by the control server 20, and provide an analysis result to the control server 20. Further, the communication device 30 may receive the analysis result, information or data from the control server 20 to simply output it. In addition, the communication device 30 may replace the role of the control server 20.

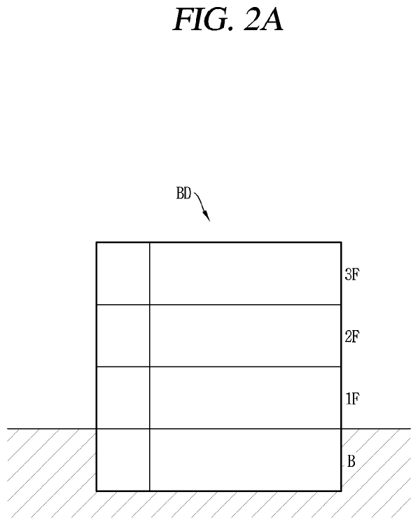

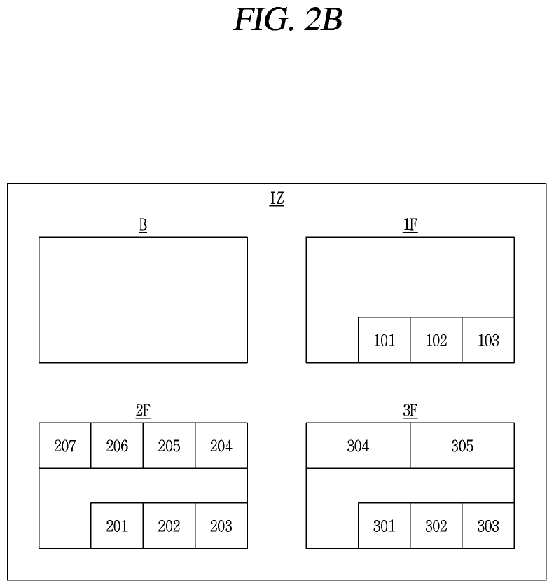

In the delivery system 1000 as described above, the delivery robot DR may travel in the traveling region as shown in FIGS. 2A to 4.

The traveling region may include at least a portion of an indoor zone IZ in a building BD with one or more floors, as shown in FIGS. 2A and 2B. In other words, the delivery robot DR may travel in at least a portion of an indoor zone IZ in a building with one or more floors. For example, first and second floors in a building with a basement and first to third floors may be included in the traveling region, thereby allowing the delivery robot DR to travel on each of the first and second floors of the building.

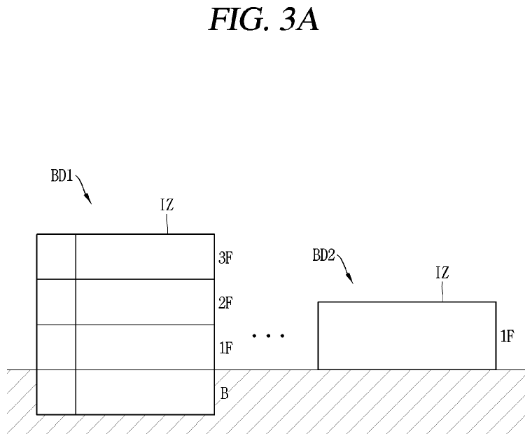

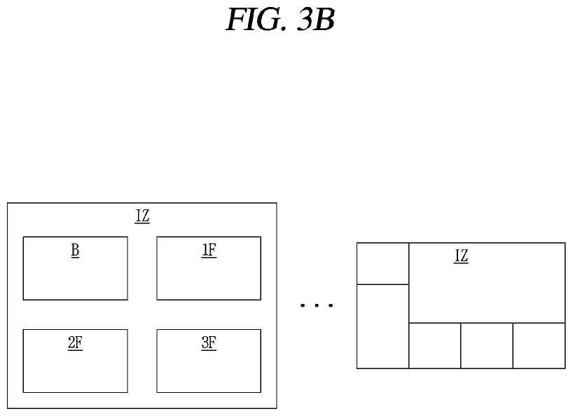

In addition, the traveling region may further include at least a portion of an indoor zone IZ in each of a plurality of buildings BD1 and BD2, as shown in FIGS. 3A and 3B. That is, the delivery robot DR may travel in at least a portion of the indoor zone IZ in each of the plurality of buildings BD1 and BD2 with one or more floors. For instance, floors of a first building with a basement and one to three floors, and a floor of a second building with a single floor (story) may be included in the traveling region, thereby allowing the delivery robot DR to travel on each of the basement, first to third floors in the first building, and the first floor of the second building.

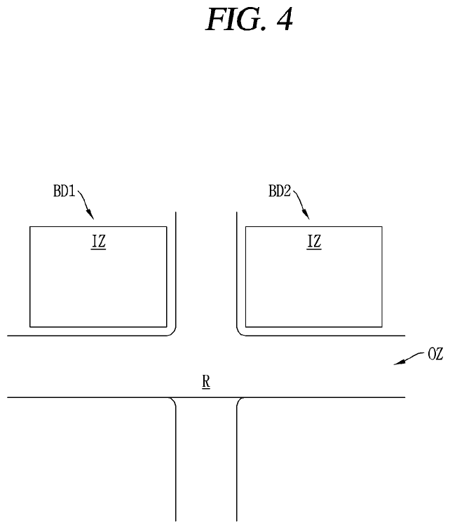

In addition, the traveling region may further include an outdoor zone OZ in one or more buildings BD1 and BD2, as shown in FIG. 4. That is, the delivery robot DR may travel in the outdoor zone OZ in the one or more buildings BD1 and BD2. For instance, a traveling route (or movement path) to a periphery in one or more buildings and the one or more buildings may be further included in the traveling region, thereby allowing the delivery robot DR to travel on the traveling route to the periphery of the one or more buildings and the one or more buildings.

The delivery system 1000 may be a system in which a delivery service is provided through the delivery robot DR in the traveling region. In the delivery system 1000, the delivery robot DR may perform a specific operation while autonomously traveling in the traveling region including indoor and outdoor zones, and, for instance, the delivery robot DR may transport products while moving from one point to a specific point in the traveling region. In other words, the delivery robot DR may perform a delivery operation of delivering the products from the one point to the specific point. Accordingly, a delivery service through the delivery robot DR may be performed in the traveling region.

Hereinafter, a detailed configuration of the delivery robot DR will be described with reference to the drawings.

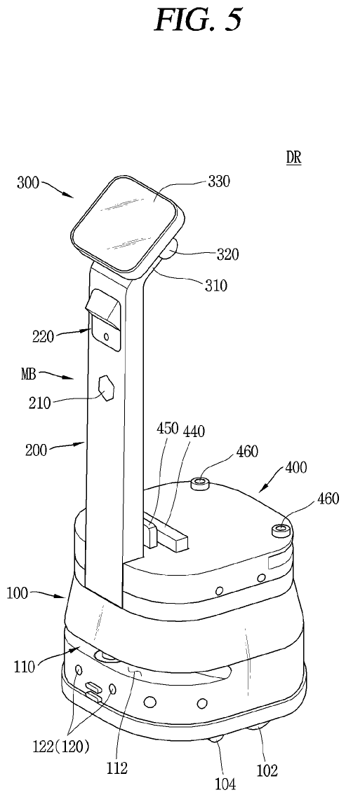

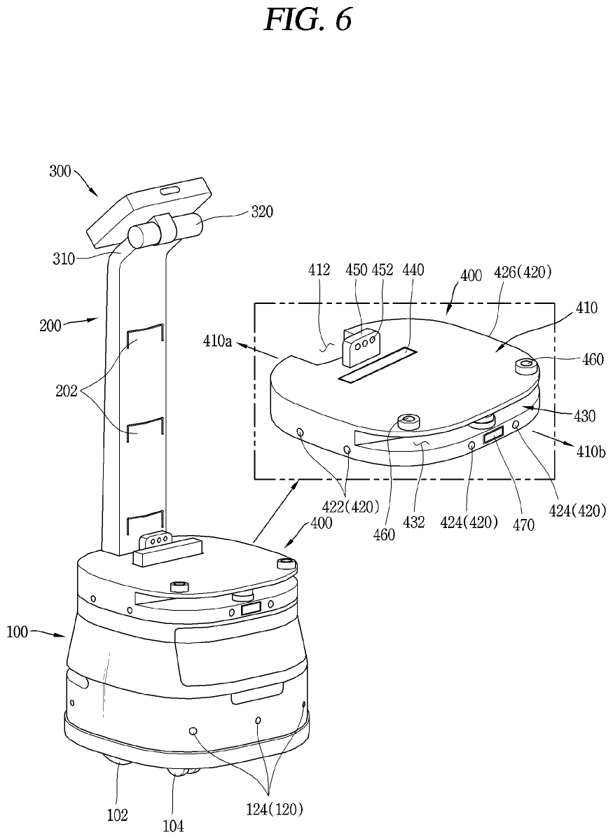

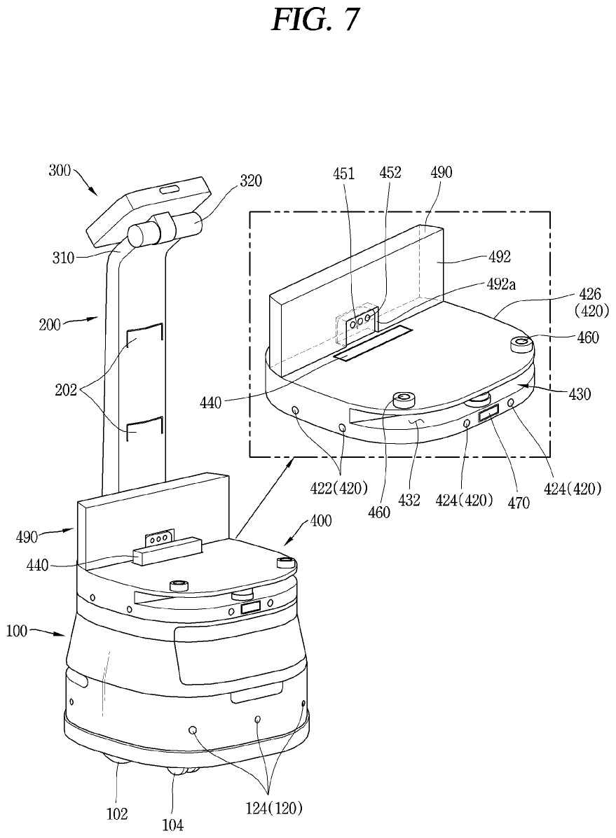

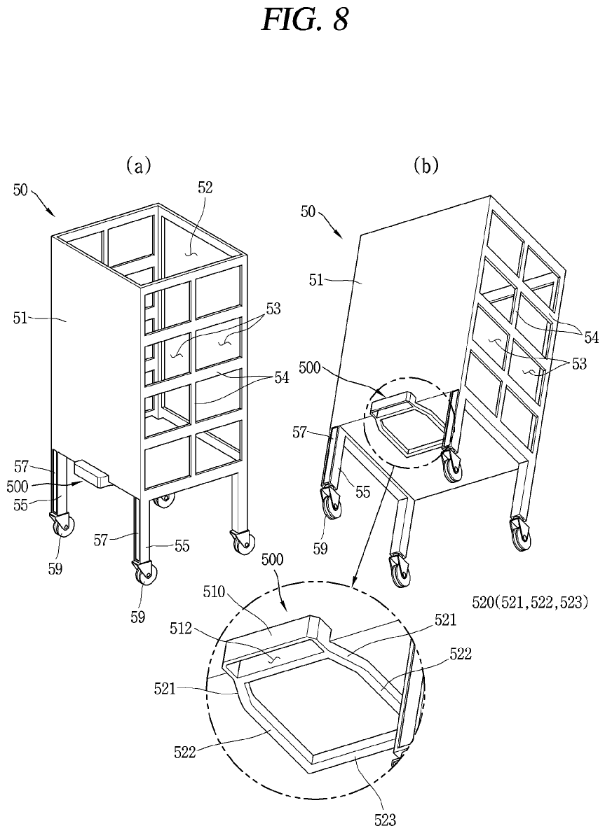

FIGS. 5 and 6 are perspective views illustrating a delivery robot according to one implementation of the present disclosure, FIG. 7 is a perspective view illustrating a delivery robot according to another implementation of the present disclosure, and FIG. 8 is a perspective view illustrating a tray and a locking unit according to one implementation of the present disclosure.

A delivery robot DR according to one implementation of the present disclosure includes a main body MB, a coupling module 400, and a locking unit 500.

The main body MB is configured to be movable with respect to the ground. In detail, the main body MB includes a moving unit 100 having wheels 102 and 104 at a lower portion thereof so as to be movable with respect to the ground. The moving unit 100 may include a first wheel 102 that provides main power and a second wheel 104 that enables steering and rotation.

The first wheel 102 may allow the main body MB to move forward or backward. In other words, the first wheel 102 may move the main body MB in a direction in which an extension unit 200 is defined and a direction opposite to the direction in which the extension unit 200 is formed.

In detail, referring to FIGS. 5, 6, and 14, the first wheel 102 may be relatively larger in size than the second wheel 104. The first wheel 102 is configured to be non-rotatable. As the first wheel 102 moves or operates, the main body MB may move forward or backward. Accordingly, the first wheel 102 can provide the main power in a direction in which the main body MB travels.

The second wheel 104 may be configured to be steerable so as to allow the main body MB to rotate.

In detail, referring to the drawings, the second wheel 104 may be relatively smaller in size than the first wheel 102. The second wheel 104 is configured to be rotatable. Accordingly, in case rotation is required when the main body MB travels, an angle of the second wheel 104 is changed to rotate the main body MB. The second wheel 104 may change a traveling (or driving) direction of the main body MB while the main body MB is traveling, or may make the main body MB rotate in place.

When the delivery robot DR is located in a narrow space, such as an elevator, in a state that the main body MB and a tray 50 are coupled to each other, the second wheel 104 may rotate the main body MB and the tray 50 in the narrow space.

The moving unit 100 may include a coupling part (not shown) and a TOF camera 120. In detail, the coupling part may be disposed on an upper surface of the moving unit 100 and be configured such that the coupling module 400 is coupled thereto. The coupling part may have a detachable structure corresponding to the coupling module 400, or be configured such that the coupling module 400 is fixed to the moving unit 100 using a spring or the like. Alternatively, the coupling part may be configured such that the coupling module 400 is fixed to the upper surface of the moving unit 100 by a screw or the like. As the coupling module 400 is coupled to the upper surface of the moving unit 100, it may have a flat upper surface with respect to the ground.

The TOF camera 120 may be disposed at a lateral surface of the moving unit 100 and be provided in plurality spaced apart from one another along a periphery of the lateral surface. Referring to FIGS. 5 and 6, the TOF camera 120 may be disposed at each of a front surface, front side surface, and rear surface of the moving unit 100. In detail, the TOF camera 120 of the moving unit 100 may include front TOF cameras 122 and rear TOF cameras 124.

The TOF camera 120 may be disposed at a lateral surface of the main body MB such that a distance between the main body MB and the ground is not far. In detail, the TOF camera 120 is disposed at a height of 5 cm to 15 cm from the ground. The main body MB may identify a distance from a nearby object through the TOF camera 120.

Meanwhile, the moving unit 100 may include a main body lidar (or Lidar, also LiDAR) 110 disposed toward the front and located above the TOF camera 120.

In detail, referring to FIGS. 5 and 6, a main body lidar groove 112 is formed toward the front of the moving unit 100. The main body lidar 110 capable of detecting a front side (or a forward direction) of the main body MB is disposed in the main body lidar groove 112.

The main body lidar 110 may have a sensing or detection zone (or range) of approximately 180 degrees forward. The main body lidar 110 may sense all around the main body MB, together with a module lidar (or Lidar) 430 of the coupling module 400 to be described hereinafter.

In addition, the main body lidar 110 may collect data of measuring distances of objects around the main body MB, together with the TOF camera 120.

The main body MB may include the extension unit 200 that extends from one end of the moving unit 100 in one direction, and a display unit 300 that extends from an end portion of the extension unit 200 at a predetermined angle with respect to the extension unit 200.

Referring to FIGS. 5 and 6, the extension unit 200 extends perpendicular to the upper surface of the moving unit 100. The extension unit 200 may be disposed at a center of one side of the moving unit 100. Here, the extension unit 200 may be disposed at the front surface of the moving unit 100.

The extension unit 200 may include a camera part 200 and a speaker 210. In addition, the extension unit 200 may include an engaging part 202 disposed at a rear surface thereof.

First, the camera part 220 is provided on a front surface of the extension unit 200. The camera part 220 may include a camera capable of capturing or shooting terrain ahead. Unlike the TOF camera 120 and the main body lidar 110, the camera part 220 may detect a difference in terrain height, a height of an object, and the like.

The camera part 220 may identify terrains of different heights and nearby objects. Accordingly, the delivery robot DR may use information obtained from the camera part 220 when setting a traveling route or path.

The speaker 210 may transmit sound to the outside. The delivery robot DR may output a current state (or status) of the delivery robot DR, a user notification message, a message for notifying pedestrians, and the like through the speaker 210.

The engaging part 202 may be formed by cutting a portion of a case at the rear surface of the extension unit 200. In detail, the engaging part 202 may be formed by cutting three straight lines perpendicular to each other of the case of the extension unit 200. Accordingly, the engaging part 202 is formed such that an upper portion or region of the case of the extension unit 200 is open by a predetermined distance, allowing at least one of the coupling module 400 and the tray 50 to be fixed into the open region.

For example, referring to FIG. 7, a damper 490 extends upward along a direction of the extension unit 200. In this case, in order to fix the damper 490 to the extension unit 200, a portion of the damper 490 and the engaging part 202 may be caught or engaged with each other to be fixed. The engaging part 202 serves to securely support an object with a different height on the extension unit 200.

The display unit 300 may include a display 330, an inclined part 310, and an angle adjustment part 320.

Referring to FIGS. 5 and 6, the display 330 may be configured to display a state (or status) of the main body MB and output a screen for controlling the main body MB.

The inclined part 310 extends from the extension unit 200 at a predetermined angle with respect to the extension unit 200 and supports the display 330. The display 330 is inclinedly disposed toward the front by the inclined part 310, allowing the display 330 to be easily seen from the above.

The angle adjustment part 320 is configured to finely adjust an angle of the display 330. The angle of the display 330 may be adjusted within a predetermined range by the angle adjustment part 320 so as to allow a user to comfortably view the display 330.

The delivery robot DR according to the present disclosure may provide a large amount of power along the front and rear sides through the first wheel 102 of the moving unit 100. In addition, steering and rotation may be enabled through the moving unit 100 including the second wheel 104.

In addition, the delivery robot DR of the present disclosure may provide recognition for the front and rear sides (or forward and rearward directions) of the delivery robot DR through the extension unit 200 disposed at one side of the moving unit 100. In addition, information regarding a distance or height of a nearby object may be identified through the main body lidar 110 of the moving unit 100, the TOF camera 120, and the camera part 220 of the extension unit 200.

Further, the delivery robot DR of the present disclosure may be easily manipulated by the user through the display unit 300.

<Coupling Module 400>

The coupling module 400 may be coupled to one surface of the main body MB. In detail, the coupling module 400 is coupled to the upper surface of the moving unit 100 of the main body MB.

The coupling module 400 includes a module body 410 and a docking part 450.

The module body 410 is coupled to one surface of the main body MB. As described above, the module body 410 is coupled to the upper surface of the moving unit 100 of the main body MB. A terminal that is in contact with the module body 410 to transmit and receive power and/or electrical signals may be provided on a coupling surface of the main body MB. Through this terminal, the coupling module 400 may receive power from the main body MB and information obtained from the coupling module 400 may be transmitted to the main body MB.

Here, an upper surface of the module body 410 may be equal to or smaller than the upper surface of the moving unit 100. In detail, as illustrated in FIGS. 5 and 6, the module body 410 may have the same area as a surface where the module body 410 is coupled to the moving unit 100. Alternatively, the module body 410 may have a smaller area than a surface where the module body 410 is coupled to the moving unit 100.

Accordingly, the coupling module 400 may be integrally coupled to the moving unit 100 of the main body MB. This may also prevent separation of the coupling module 400 from the main body MB by an external force caused when the coupling module 400 is caught or stuck externally due to its larger size.

The docking part 450 may be provided at the upper surface of the module body 410 in a protruding manner. The docking part 450 is disposed adjacent to the extension unit 200. The docking part 450 may be configured to determine whether or not docking is completed according to the proximity of the tray 50.

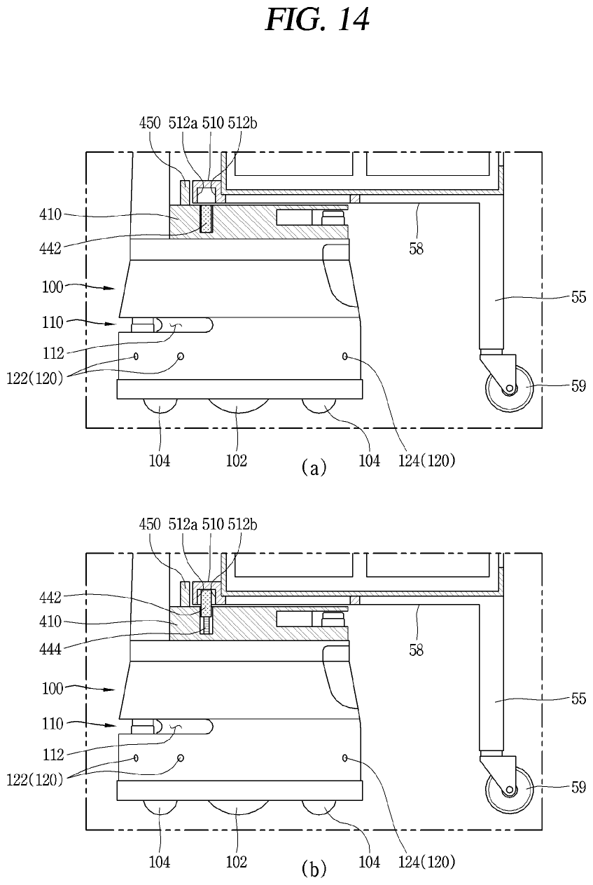

In detail, the docking part 450 includes a docking TOF camera 452 disposed toward the rear of the main body MB. Referring further to FIG. 14, the docking TOF camera 452 of the docking part 450 may determine whether or not docking is completed according to the proximity of a locking part 510 of the locking unit 500 to be described hereinafter.

The coupling module 400 includes an actuator (or actuator unit) 440 configured to be driven to be coupled with the locking unit 500 when the coupling module 400 and the tray 50 are located adjacent to each other.

In detail, referring to FIGS. 5 and 6, the actuator 440 is disposed adjacent to the extension unit 200. The actuator 440 that is defined at the coupling module 400 includes an actuator bar 442 and a drive (or driving) part 444.

The actuator bar 442 moves up as the tray 50 and the coupling module 400 are docked at the docking part 450. That is, the locking unit 500 and the coupling module 400 are coupled to each other by the actuator bar 442. When the main body MB travels in a state that the locking unit 500 and the coupling module 400 are coupled to each other, the main body MB, the coupling module 400, the locking unit 500, and the tray 50 are all movable.

The drive part 444 is configured to operate the actuator bar 442. In detail, referring to FIG. 14, when the locking unit 500 and the coupling module 400 are located at positions available for docking with each other, the docking part 450 transmits a signal to a controller (or control unit) upon sensing this. When the signal is received, the controller may transmit a signal to the actuator 440 such that the actuator bar 442 can be driven by the drive part 444.

The actuator bar 442 may be disposed in a direction opposite to the extension unit 200 based on the docking part 450. The actuator bar 442 may be inserted into the module body 410 before the coupling module 400 and the tray 50 are docked.

In detail, referring to FIG. 14, the actuator bar 442 may be disposed at the same height as an upper surface of the coupling module 400 in an undocked state. Alternatively, the actuator bar 442 may be located more inward than the upper surface of the coupling module 400 in the undocked state.

In another implementation, the actuator may be provided with an actuator bar that protrudes in a horizontal direction and is configured to grip the locking unit 500, instead of the actuator bar 442 that protrudes in a vertical direction.

Referring to FIG. 6, the module body 410 may be provided with a front groove 412 that is concavely recessed to allow the extension unit 200 to be inserted therein. The front groove 412 may be formed toward a front side (or direction) 410a of the module body 410. The module body 410 may be integrally coupled to the upper surface of the moving unit 100 through the front groove 412.

A module TOF camera 420 that is disposed at a lateral surface of the module body 410 may be provided in plurality spaced apart from one another along a periphery of the module body 410.

In detail, the module TOF camera 420 may include module side TOF cameras 422 and 426 disposed at both sides of the module body 410, and module rear TOF cameras 424 disposed at a rear surface of the module body 410. The module TOF camera 420 may measure a distance between the main body MB and nearby objects, together with the TOF camera 120 of the main body MB. Unlike the TOF camera 120 of the main body MB, the module TOF camera 420 may be disposed at a distance of 20 cm to 40 cm from the ground.

The module body 410 may include a module lidar 430 that is formed toward the rear of the module body 410 and is configured to scan the rear side of the main body MB.

In detail, a module lidar groove 432 is formed toward a rear side (or direction) 410b of the module body 410. In addition, the module lidar 430 may be defined in the module lidar groove 432. The module lidar 430 may measure a distance of objects around the main body MB, together with the main body lidar 110 that is disposed at the moving unit 100.

The module lidar 430 and the module rear TOF camera 120 of the module body 410 may also be used to measure a distance when the main body MB and the tray 50 described hereinafter are located adjacent to each other.

The module body 410 may include a rolling pin 460 that is disposed on the upper surface of the module body 410 in a direction opposite to a direction in which the actuator bar 442 is disposed and is rotatably provided.

The rolling pin 460 may be disposed adjacent to the rear surface of the module body 410. Two rolling pins 460 may be provided. The rolling pins 460 may be disposed adjacent to both side surfaces of the module body 410, respectively, in a spaced manner. The rolling pins 460 may be in contact with the locking unit 500 described hereinafter to guide the locking unit 500 and the tray 50. The rolling pins 460 may be configured to rotate when being in contact with the locking unit 500.

Meanwhile, the module body 410 may further include a module camera part 470. The module camera part 470 may be disposed between the module rear TOF cameras 424. The module camera part 470 may acquire information regarding objects ahead of and behind the main body MB, together with the camera part 220 of the main body MB.

The delivery robot DR according to the present disclosure may include the coupling module 400 that is integrally coupled to the main body MB. In addition, since the coupling module 400 is detachably coupled to the main body MB, different types of coupling modules 410 can be coupled to the main body MB according to a type of tray 50 and the like, thereby increasing the use of the main body MB. <Locking Unit 500>

The locking unit 500 is coupled to the tray 50 that is configured to be movable. In detail, referring to FIG. 8, the locking unit 500 may be coupled to a lower surface and side surface of the tray 50.

The locking unit 500 may include a locking part 510 and a guide part 520.

The locking part 510 may be mounted to a side surface adjacent to the lower surface of the tray 50. A locking groove 512 into which the actuator bar 442 is inserted may be defined in the locking part 510. The locking groove 512 corresponds to a shape of the actuator bar 442 so as to allow the actuator bar 442 to be inserted therein.

As the locking part 510 is mounted to the side surface of the tray 50, the locking part 510 can get close to the docking part 450 before the side surface of the tray 50 comes near to the docking part 450 when approaching close to the coupling module 400.

However, unlike the above description of disposing the locking part 510 at the side surface of the tray 50, the locking part 510 may be disposed at the lower surface of the tray 50. This may prevent the side surface of the tray 50 from protruding to one side.

The guide part 520 may extend from the locking part 510 and be greater in width than the locking part 510. Here, at least a portion of the guide part 520 may be guided by the rolling pin 460.

The guide part 520 may include first portions 521, second portions 522, and a third portion 523.

The first portions 521 may extend from the locking part 510 and be inclined with respect to the locking part 510.

The first portions 521 extend obliquely from both sides of the locking part 510, and thus, the guide part 520 is greater in width than the locking part 510.

The second portions 522 may have a width that corresponds to a separation distance between the rolling pins 460 that are disposed at both sides of the module body 410. The second portions 522 may extend in a lengthwise (or longitudinal) direction of the guide part 520.

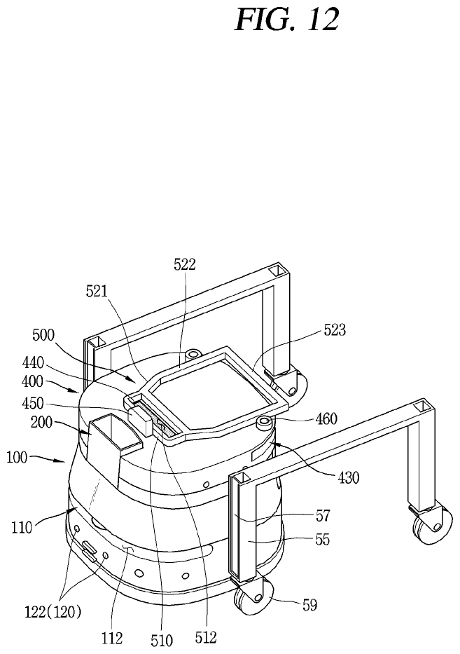

In detail, referring to FIG. 12, when the locking unit 500 is disposed in a position to be coupled to an upper end of the coupling module 400, the second portions 522 are disposed between the rolling pins 460 disposed at the both sides of the module body 410.

If a width between the second portions 522 is equal to or greater than a width between the rolling pins 460, the locking unit 500 is not inserted between the rolling pins 460, and the width between the second portions 522 is considerably narrower (or smaller) than the width between the rolling pins 460, the rolling pins 460 may not properly guide the locking unit 500 when inserting the locking unit 500 between the rolling pins 460. Accordingly, the width between the second portions 522 that are spaced apart from each other corresponds to the width between the rolling pins 460.

The third portion 523 may connect the second portions 522 disposed at both sides of the locking part 510. Accordingly, the second portions 522 may be prevented from being moved by an external force applied in an inward direction.

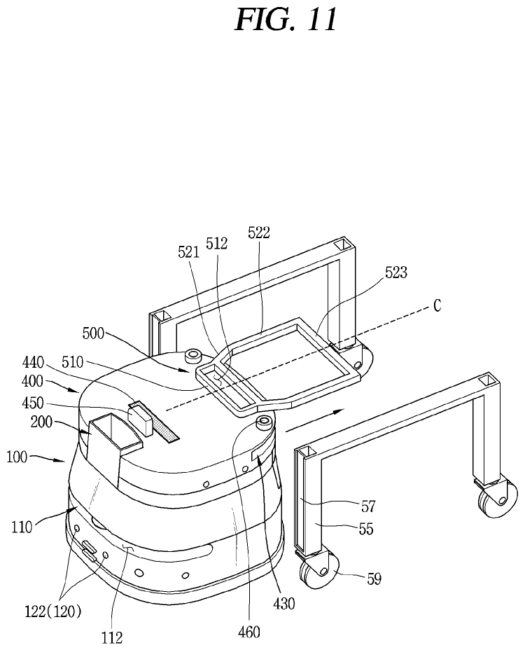

Referring to FIGS. 11 and 12, the rolling pins 460 are disposed on the upper surface of the coupling module 400. The rolling pins 460 may guide a movement path of the guide part 520 by being brought into contact with the guide part 520, namely, the first portions 521 and the second portions 522 while the main body MB is entering below the tray 50.

In other words, as the rolling pins 460 guide the guide part 520, the locking unit 500, namely, the tray 50 may be located at a desired or intended position on the coupling module 400. During the process of guiding the guide part 520, the rolling pins 460 may be rotated by being in contact with the first portions 521 and the second portions 522.

Referring to FIG. 8, the tray 50 may include a front surface 51, a rear surface 52 that is open, side frames 54 in which a plurality of opening grooves 53 are formed, leg parts 55, reflective sheets 57 provided at front surfaces of the leg parts 55, respectively, a tray bottom surface 58, and tray wheels 59.

The front surface 51 of the tray 50 may be blocked or closed to prevent a cargo loaded on the tray 50 from falling out while traveling or stopping. The rear surface 52 of the tray 50 is open such that items can be easily loaded. However, an openable door may be provided on the rear surface 52 of the tray 50.

The opening grooves 53 may be formed on side surfaces of the tray 50 to allow an inside of the tray 50 to be visually recognized from the outside. Alternatively, unlike the drawing, an additional frame connecting the side surfaces of the tray 50 may be provided. The side frames 54 are provided at the side surfaces of the tray 50, respectively, so as to prevent a cargo loaded on the tray 50 from falling out while traveling.

The reflective sheets 57 may be provided on the front surfaces of the leg parts 55, respectively. The leg parts 55 may each have a predetermined thickness or more to be easily recognized by the module TOF camera 420 and the module lidar 430. For example, the leg parts 55 may each have a thickness of 5 cm or more, so as to be easily recognized by the module TOF camera 420 and the module lidar 430.

The reflective sheets 57 attached to the respective leg parts 55 may better reflect signals transmitted from the module TOF camera 420 and the module lidar 430 of the coupling module 400. This may allow the module TOF camera 420 and the module lidar 430 to recognize the leg parts 55 of the tray 50 more easily. Accordingly, a position of the main body MB may be more accurately aligned when the main body MB and the locking unit 500 are coupled to each other.

[FIG. 7: Implementation Including Damper 490]

A delivery robot DR according to another implementation of the present disclosure in FIG. 7 may further include a damper (or damper part) 490. In detail, the damper 490 may be configured to cover or surround the docking part 450. The damper 490 may extend along a direction in which the extension unit 200 extends with respect to the moving unit 100.

The damper 490 may include a damper groove 492a through which the docking part 450 is exposed to the outside and into which the docking part 450 is inserted.

A front surface 492 of the damper 490 in which the damper groove 492a is defined may protrude more to the actuator 440 than a front surface 451 of the docking part 450 that is exposed to the outside.

In detail, referring to FIG. 7, the front surface 451 of the docking part 450 disposed in the damper groove 492a is located more inward than the front surface 492 of the damper 490.

In the delivery robot DR according to this implementation of the present disclosure, as the docking part 450 is disposed to be covered by the damper 490, and the front surface of the damper 490 protrudes more than the front surface of the docking part 450, the docking part 450 can be prevented from being damaged by the locking part 510 when the locking part 510 is excessively moved toward the docking part 450.

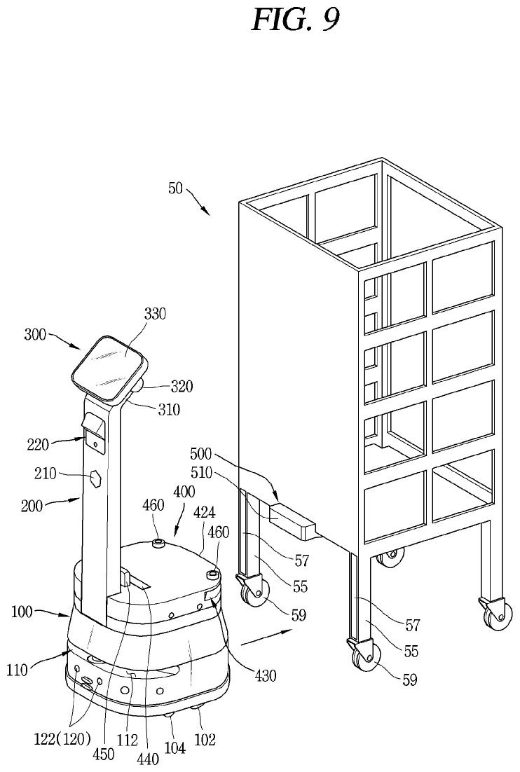

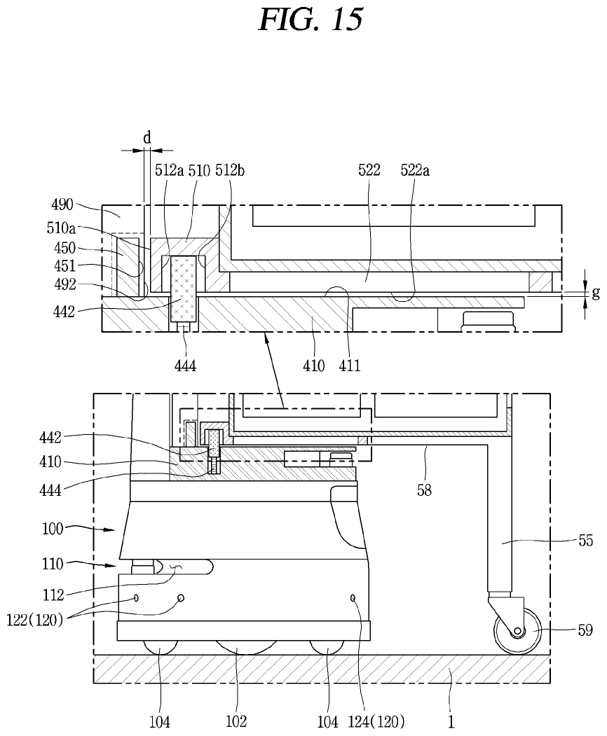

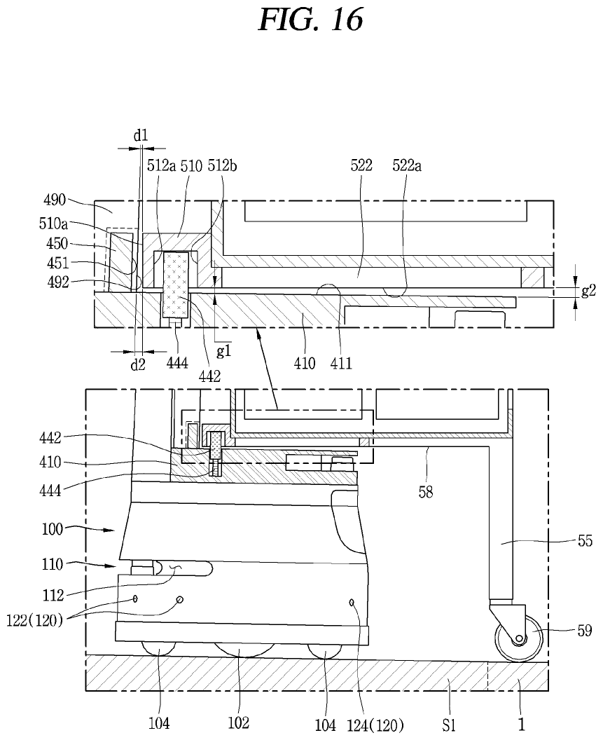

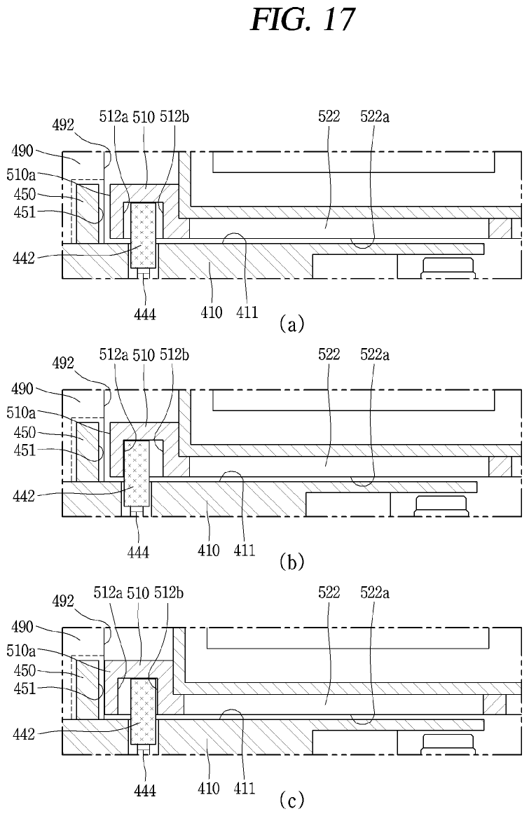

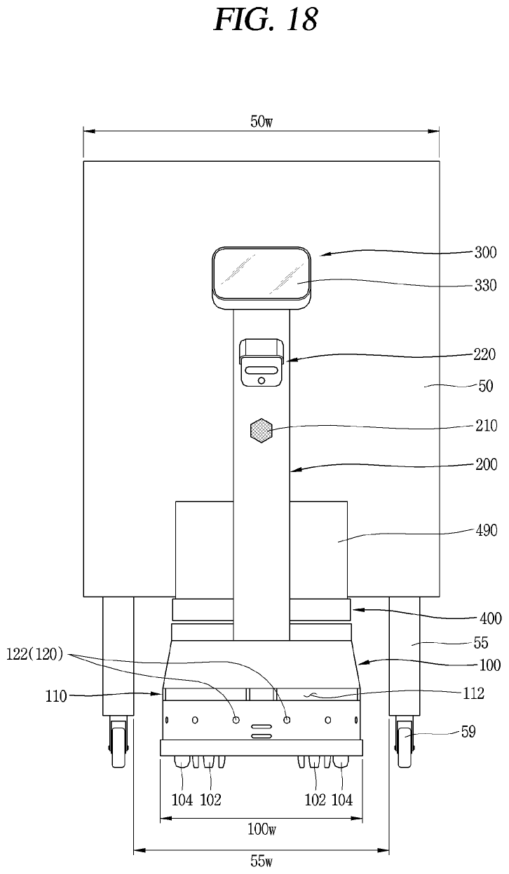

FIGS. 9 to 13 illustrate a process in which the coupling module 400 and the locking unit 500 are coupled by the actuator 440 as the delivery robot DR in FIG. 5 moves to be adjacent to the tray 50; FIG. 14 is a cross-sectional view illustrating a state of coupling the coupling module 400 and the locking unit 500; FIG. 15 is a cross-sectional view illustrating a coupled state of the delivery robot DR and the tray 50; FIG. 16 is a cross-sectional view illustrating a positional relationship between the coupling module 400 and the locking unit 500 when the delivery robot DR that is coupled to the tray 50 travels on an incline; FIG. 17 is a cross-sectional view illustrating a positional relationship between the coupling module 400 and the locking unit 500 when the delivery robot DR that is coupled to the tray 50 stops while traveling; and FIG. 18 is a front view illustrating a coupled state of the delivery robot DR and the tray 50. For the sake of better understanding, some portions of the tray 50 are not shown in FIGS. 11 to 13.

Referring to FIGS. 9 to 12, in order for docking, the main body MB that is coupled to the coupling module 400 travels or moves backward to the tray 50 to reach a docking position. As described above, the locking unit 500 may be guided by the rolling pins 460 when the coupling module 400 approaches the locking part 510.

First, referring to FIG. 9, the delivery robot DR is aligned such that a rear surface of the main body MB is directed to the tray 50 in a state that the coupling module 400 is coupled to the main body MB, so as to travel backwards under a bottom surface of the tray 50.

Of the locking unit 500 mounted to the tray 50, the locking part 510 protrudes from the side surface of the tray 50, which allows the delivery robot DR to identify a position of the locking unit 500 through the module lidar 430.

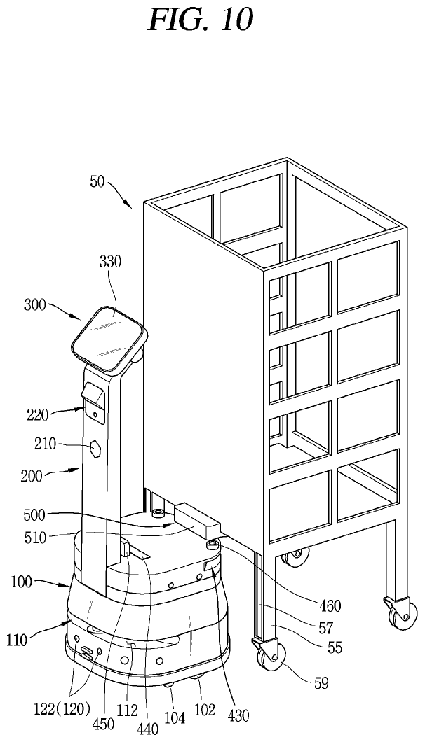

Referring to FIG. 10, a portion of the main body MB enters below the tray 50. Here, the locking unit 500 may be guided by the rolling pins 460. In detail, when the locking unit 500 is brought into contact with the rolling pins 460, the rolling pins 460 may rotate to guide the locking unit 500 to be inserted between the rolling pins 460 disposed at the both sides of the module body 410.

In addition, the docking TOF camera 452 of the docking part 450 may identify a position of the locking part 510 and adjust a position of the main body MB so as to allow the locking part 510 to be located between the rolling pins 460.

Referring to FIG. 11, a more portion of the main body MB enters below the tray 50. Here, at least a portion of the guide part 520 may be guided by the rolling pins 460. In detail, the first portions 521 of the guide part 520 may be guided by the rolling pins 460.

As the first portions 521 have a shape that is wide open on both sides with respect to the locking part 510, the first portions 521 can be brought into contact with the rolling pins 460 when the main body MB enters below the tray 50, allowing a position of the tray 50 or the main body MB to be adjusted. Accordingly, the position of the locking part 510 can be properly matched with the actuator 440. In other words, the main body MB can enter below the tray 50 in a manner that its center is aligned with a center C of the tray 50.

Referring to FIG. 12 and (a) of FIG. 14, the main body MB moves further toward the tray 50. During this process, the second portions 522 of the guide part 520 are disposed between the rolling pins 460. The rolling pins 460 and the second portions 522 may be in contact with each other. As the main body MB moves toward the tray 50, the rolling pins 460 in contact with the second portions 522 rotate to thereby allow the main body MB to be inserted below the tray 50. As the second portions 522 are disposed between the rolling pins 460, the position of the locking part 510 may be more properly matched with the actuator 440.

When the locking part 510 is located adjacent to the docking part 450, the docking part 450 detects this through the TOF camera 452. In addition, the main body MB may stop at a position suitable for docking.

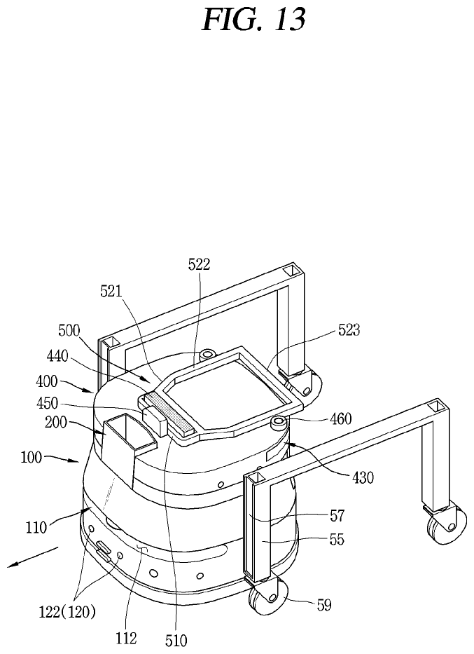

Referring to FIG. 13 and (b) of FIG. 14, as the actuator 440 of the coupling module 400 is operated, the actuator bar 442 is inserted into the locking part 510. Accordingly, the coupling module 400 and the locking unit 500 can be docked.

Meanwhile, referring to FIG. 15, a gap g may be formed between the coupling module 400 and the locking unit 500. More specifically, the gap g is defined between the coupling module 400 and a lower surface 522a of the second portion 522. This gap serves to prevent weight of the tray 50 in the direction of gravity from being transmitted to the coupling module 400. Further, due to the gap g between the coupling module 400 and the locking unit 500, the weight of the tray 50 may not be transferred to the coupling module 400 even when the main body MB that is coupled to the tray 50 moves on an incline.

Referring to FIG. 16, when the main body MB is moved from a flat ground (or surface) 1 to an inclined ground s1, a height of the front surface of the main body MB may be increased relative to a height of the rear surface of the main body MB. However, since the gap g exists between the coupling module 400 and the locking unit 500, a front gap g1 between the coupling module 400 and the locking unit 500 is reduced. That is, the weight of the tray 50 is not transmitted to the coupling module 400. Meanwhile, as the height of the front surface of the main body MB is increased relative to the height of the rear surface of the main body MB, a rear gap g2 between the coupling module 400 and the locking unit 500 may increase. With this structure, the present disclosure can prevent the weight of the tray 50 from being transferred when the delivery robot DR travels on an incline.

When the locking unit 500 and the coupling module 400 are coupled by the actuator 440, the actuator bar 442 may be disposed to be spaced apart from at least one of a front surface 512a and a rear surface 512b of the locking groove 512 that define the locking groove 512. That is, when the actuator bar 442 is inserted into the locking groove 512, a separation distance exists between the actuator bar 442 and the locking groove 512.

In detail, referring to (a) of FIG. 14, the locking groove 512 have the front surface 512a in the front direction and the rear face 512b in the rear direction that are opposite to each other. Referring to (b) of FIG. 14, when the actuator bar 442 is inserted into the locking groove 512, the actuator bar 442 may not come in contact with the front surface 512a and the rear surface 512b of the locking groove 512.

Meanwhile, referring to FIG. 15, a separation distance d may be defined between a front surface 510a of the locking part 510 and the front surface 492 of the damper 490. At this time, since the front surface 451 of the docking part 450 is located more inward than the front surface 492 of the damper 490, a separation distance d may also be defined between the front surface 510a of the locking part 510 and the front surface 451 of the docking part 450.

As the separation distance d exists between the front surface 510a of the locking part 510 and the front surface 492 of the damper 490, the damper 490 and the locking part 510 may not be brought into contact with each other when the main body MB travels in an inclined section.

In detail, referring to FIG. 16, when the main body MB moves from the flat ground 1 to the inclined ground s1, the height of the front surface of the main body MB may be increased relative to the height of the rear surface of the main body MB. Here, a separation distance dl between the damper 490 and an upper portion of the locking part 510 may be relatively reduced, and a separation distance d2 between the damper 490 and a lower portion of the locking part 510 may be greater than or equal to the original separation distance d.

As the separation distance d exists between the front surface 510a of the locking part 510 and the front surface 492 of the damper 490, the damper 490, and the docking part 450 may not come in contact with the locking part 510 when the main body MB travels in an inclined section.

In addition, as the separation distance d is defined between the front surface 510a of the locking part 510 and the front surface 492 of the damper 490, transmission of weight of the tray 50 to the actuator bar 442 can be reduced when the main body MB stops while traveling.

In detail, (a) of FIG. 17 illustrates a state immediately after the actuator bar 442 being inserted into the locking groove 512.

Here, the actuator bar 442 may be spaced apart from the front surface 512a and the rear surface 512b of the locking groove 512. In other words, a width of the actuator bar 442 is narrower (or smaller) than that of the locking groove 512, and thus, the actuator bar 442 drawn into the locking groove 512 can be spaced apart from the front surface 512a and/or the rear surface 512b of the locking groove 512.

Referring to (b) of FIG. 17, the main body MB is moved forward as it starts traveling. Accordingly, the actuator bar 442 moves and comes in contact with the front surface 512a of the locking groove 512. The actuator bar 442 presses the front surface 510a of the locking part 510 so that force to move the tray 50 is applied.

(c) of FIG. 17 illustrates a state in which the main body MB stops while traveling. When the main body MB stops, the tray 50 may be moved forward by inertia. As the tray 50 is moved forward, the locking part 510 is moved forward. The front surface 510a of the locking part 510 may be brought into contact with the front surface 492 of the damper 490. Accordingly, an inertia force of the tray 50 can be absorbed by the damper 490 through contact with the damper 490.

That is, since the inertia force of the tray 50 is absorbed by the damper 490, transmission of weight of the tray 50 to the actuator bar 442 can be reduced when the main body MB stops while traveling.

In addition, as described above, the docking part 450 may include the damper groove 492a through which the damper 490 is exposed to the outside and into which the docking part 450 is inserted, and the front surface 492 of the damper 490 may protrude more to the actuator 440 than the front surface 451 of the docking part 450 that is exposed outside.

When the tray 50 moves relatively forward with respect to the main body MB as the main body MB is switched to a stationary state from a moving state, the front surface 510a of the locking part 510 is brought into with the damper 490. Accordingly, transmission of inertial force of the tray 50 to the docking part 450 can be reduced.

Referring to FIG. 18, the main body MB that is docked with the tray 50 may be disposed at the middle of the tray 50. An overall width 50w of the tray 50 should be within a range of the standard lift (or elevator) size. More specifically, the overall width 50w of the tray 50 should be within a range of the standard lift size for 10 persons.

A width 100w of the main body MB is narrower than a width 55w between the leg parts 55 of the tray 50. Further, an angle between the tray 50 and the main body MB may be widened or increased during steering and rotation while the main body MB is traveling, and thus, the width 100w of the main body MB may, preferably, be defined in a spaced manner from the leg parts 55 of the tray 50 by a predetermined distance.

In other words, when the tray 50 is rotated as the main body MB rotates, a distance between the main body MB and the tray leg parts 55 may be reduced, and thus, the main body MB may, preferably, have a narrow width enough to absorb this clearance or gap.

Although the foregoing description has been given with reference to the preferred implementations, it will be understood by those skilled in the art that various modifications, changes, deletion, or addition of the components can be made without departing from the scope of the present disclosure disclosed in the following claims. Therefore, the scope of the present disclosure should not be limited to the implementations described above.

1. A delivery robot comprising:
a main body configured to be movable with respect to a ground;
a coupling module coupled to one surface of the main body; and
a locking unit coupled to a tray that is configured to be movable,
wherein the coupling module comprises an actuator configured to be driven to be coupled with the locking unit when the coupling module and the tray are located adjacent to each other.

2. The delivery robot of claim 1, wherein the main body comprises:
a moving unit including a wheel configured to be movable with respect to the ground;
an extension unit extending in one direction from one end of the moving unit; and
a display unit extending from an end portion of the extension unit at a predetermined angle with respect to the extension unit.

3. The delivery robot of claim 2, wherein the moving unit comprises:
a coupling part disposed on an upper surface thereof and through which the coupling module is coupled; and
a TOF camera disposed at a lateral surface thereof and provided in plurality spaced apart from one another along a periphery of the lateral surface.

4. The delivery robot of claim 3, wherein the moving unit further comprises:
a first wheel configured to move the main body in a direction in which the extension unit is defined and a direction opposite to the direction in which the extension unit is defined; and
a second wheel configured to be steerable to allow the main body to rotate.

5. The delivery robot of claim 3, wherein the moving unit further comprises a main body lidar disposed toward the front and disposed above the TOF camera.

6. The delivery robot of claim 3, wherein the extension unit extends perpendicular to the upper surface of the moving unit, and
wherein the extension unit comprises:
a camera part provided at a front surface thereof and including a camera capable of shooting terrain ahead;
a speaker that transmits sound to the outside; and
an engaging part disposed at a rear surface thereof and configured to fix at least one of the coupling module and the tray.

7. The delivery robot of claim 2, wherein the display unit comprises:
a display configured to display a state of the main body and output a screen for controlling the main body;
an inclined part configured to support the display; and
an angle adjustment part configured to adjust an angle of the display.

8. The delivery robot of claim 2, wherein the coupling module comprises:
a module body coupled to one surface of the main body; and
a docking part provided at an upper surface of the module body in a protruding manner and configured to determine whether or not docking is completed according to proximity of the tray, and
wherein the actuator comprises:
an actuator bar configured to move up when the tray and the coupling module are docked at the docking part; and
a drive part configured to operate the actuator bar.

9. The delivery robot of claim 8, wherein the docking part is disposed adjacent to the extension unit,
wherein the actuator bar is disposed in a direction opposite to the extension unit with respect to the docking part, and
wherein the actuator bar is inserted into the module body before the coupling module and the tray are docked.

10. The delivery robot of claim 9, wherein the module body is provided with a front groove that is concavely recessed to allow the extension unit to be inserted therein, and
wherein a plurality of module TOF cameras are provided at a lateral surface of the module body to be spaced apart from one another along a periphery of the module body.

11. The delivery robot of claim 10, wherein the module body includes a module lidar formed toward the rear thereof and configured to scan a rear side of the main body.

12. The delivery robot of claim 9, wherein the upper surface of the module body is equal to or smaller than the upper surface of the moving unit, and
wherein the module body includes rolling pins disposed on the upper surface of the module body in a direction opposite to a direction in which the actuator bar is disposed and configured to be rotatable.

13. The delivery robot of claim 12, wherein the locking unit comprises:
a locking part mounted to one end of the tray and in which the actuator bar is inserted; and
a guide part extending from the locking part and having a width greater than a width of the locking part, and
wherein at least a portion of the guide part is guided by the rolling pins.

14. The delivery robot of claim 13, wherein the guide part comprises:
first portions extending from the locking part in an inclined manner;
second portions having a width that corresponds to a separation distance between the rolling pins disposed at both sides of the module body and extending in a lengthwise direction of the guide part; and
a third portion connecting the second portions disposed at both sides of the locking part.

15. The delivery robot of claim 14, wherein the first portions are guided by the rolling pins when the coupling module approaches the locking part.

16. The delivery robot of claim 14, wherein a gap is defined between the coupling module and the second portions.

17. The delivery robot of claim 14, wherein the coupling module includes a damper disposed at an upper surface of the coupling module, configured to surround the docking part, and extending along an extension direction of the extension unit.

18. The delivery robot of claim 17, wherein the damper includes a damper groove through which the docking part is exposed to the outside and into which the docking part is inserted, and
wherein a front surface of the damper in which the damper groove is defined protrudes more to the actuator than a front surface of the docking part that is exposed to the outside.

19. The delivery robot of claim 18, wherein the locking part is provided with a locking groove into which the actuator bar is inserted, and
wherein the actuator bar is disposed to be spaced apart from at least one of front and rear surfaces of the locking groove that define the locking groove.

20. The delivery robot of claim 19, wherein a front surface of the locking part is brought into contact with the damper when the tray moves forward relative to the main body as the main body is switched to a stationary state from a moving state.
